(19) United States
(12) Patent Application Publication
(10) Pub. No.: US 2017/0278008 A1
(43) Pub. Date: Sep. 28, 2017

(54) KM-Logic: Computationally Efficient Real-Time MIMO Fuzzy Inference System

(71) Applicant: Government of the United States, as represented by the Secretary of the Air Force, Wright-Patterson AFB, OH (US)

(72) Inventors: Matthew A. Clark, Springfield, OH (US); Kuldip S. Rattan, Beavercreek, OH (US)

(21) Appl. No.: 15/462,964

(22) Filed: Mar. 20, 2017

Related U.S. Application Data
(60) Provisional application No. 62/313,183, filed on Mar. 25, 2016.
(60) Provisional application No. 62/362,267, filed on Jul. 14, 2016.

(51) Int. Cl. G06N 7/02; G06N 5/04; G06F 7/523

(52) U.S. Cl. CPC G06N 7/02; G06F 7/523; G06N 5/048

(57) ABSTRACT

A system and method of determining an output of an n-input fuzzy logic system are provided. A plurality of membership functions associated with a corresponding plurality of inputs is determined along with a list of fuzzy rules for the n-input fuzzy logic system. An input of the plurality of inputs is selected. Two active rules and their corresponding output values are selected from the list of rules. Membership values of two active membership functions are determined. An output of the n-input fuzzy system is calculated by multiplying the two membership values with the output of the two active rules and is saved. Recursively repeating, for each additional input, the determining and calculating steps and multiplying the output with the saved output, then saving the new output.

### CROSS-REFERENCE TO RELATED APPLICATIONS

This application claims the benefit of and priority to U.S. Provisional Application Ser. No. 62/313,183, entitled “KM-Logic: Computationally Efficient, Real-Time MIMO Fuzzy Inference System,” filed on Mar. 25, 2016, and U.S. Provisional Application Ser. No. 62/362,267, entitled “KM-Logic: Computationally Efficient, Real-Time MIMO Fuzzy Inference System,” filed on Jul. 14, 2016, 2016, the entireties of which are incorporated by reference herein.

### RIGHTS TO THE GOVERNMENT

The invention described herein may be manufactured and used by or for the Government of the United States for all governmental purposes without the payment of any royalty.

### BACKGROUND OF THE INVENTION

Field of the Invention. The present invention generally relates to fuzzy logic system.

Description of the Related Art.

In real world applications such as industrial processes and process control, precise knowledge of the system being controlled is not completely known and the system behavior is generally nonlinear. Therefore, it is difficult to precisely control these systems with conventional techniques. However, fuzzy logic controllers (FLCs) have demonstrated excellent performance for these types of systems. Unlike traditional two valued logic having logic states of 0 or 1, fuzzy set theory allows a degree of truth for a variable to exist somewhere in the range [0,1]. For example, if pressure is a linguistic variable that describes an input, then the terms low, medium, high and dangerous describe the fuzzy set for the pressure variable. For control applications, linguistic variables describe the control inputs for dynamic plants and rules define the relationships between the inputs. Thus, precise knowledge of a plant's transfer function is not necessary for design and implementation of the controller. Contemporary FLCs have also shown improved performance over classical controllers when the plant transfer function is known. The thrust of early efforts in fuzzy control involved replacing humans in the control loop by describing the operators' actions in terms of linguistic rules.

One of the drawbacks of fuzzy logic controllers, however, is the computation time required to combine all the membership values of every input to form a firing value for each rule. For a given number of membership functions in each input fuzzy set, the number of fuzzy rules increases geometrically with the number of inputs. For example, for a two input fuzzy system with 7 membership functions each, there are 7²=49 fuzzy rules. However, for a four input fuzzy system with 7 membership functions each, there are 7⁴=2401 fuzzy rules. This geometrically progression of the number of rules becomes an obstacle for practical application of multi-input fuzzy system because of the time it takes to implement these systems. For example, using a python implementation on a 2.7 GHz CPU and 16 GB RAM, it takes 0.265 milliseconds to produce an output for a 2-input systems. However, this time increases to 11.5 milliseconds for a 4-input system. Therefore, practical applications are generally restricted to two or at most three inputs in contemporary fuzzy systems.

Accordingly, there is a need in the art for a more computationally efficient multi-input fuzzy logic system.

### SUMMARY OF THE INVENTION

Fuzzy logic controllers have demonstrated excellent performance in real world applications where a precise knowledge of the system being controlled is not completely known and their behavior is generally nonlinear. One of the drawbacks of fuzzy logic controllers, however, is the computation time it takes to combine all the membership values of every input to form firing value for each rule. For a given number of membership functions in each input fuzzy set, the number of fuzzy rules increase geometrically with the number of inputs. This geometric progression of the number of rules becomes an obstacle for practical application of multi-input fuzzy system because of the time it takes to implement these systems. To overcome this geometric progression, embodiments of the invention provide a novel recursive algorithm to implement multi-input fuzzy systems. In this method each input is fuzzy partitioned into membership functions for which only two membership functions are active and a sum of their membership values is equal to one for any crisp input. This reduces the firing rules resulting in significantly reduced implementation time.

A system and method of determining an output of an n-input fuzzy logic system are provided. A plurality of membership functions associated with a corresponding plurality of inputs to the n-input fuzzy logic system are defined along with a list of fuzzy rules. For a first input of the fuzzy system, two active rules and their corresponding output values are selected from the list of rules. The membership values of the two active membership functions are determined and the output of the fuzzy system is calculated by multiplying the two membership values with the output of the two active rules. This output is then saved. If the fuzzy system has additional inputs, the steps of selecting an input, determining the outputs of the two active rules, and calculating the output by multiplying the outputs of the two active rules with the two membership values are recursively repeated for each input. At the end of each set of steps, the newly calculated output is multiplied by the saved output of the previous steps. This new output is then saved and process continues until all inputs have been processed. If there are no additional inputs, the saved output may be output to the control system for action by a control system on a process being controlled.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a schematic diagram showing components of an exemplary fuzzy logic controller;

FIG. 2 is a graph showing three triangular input membership functions;

FIG. 3 is a graph showing three triangular output membership functions;

FIG. 4 is a flow diagram illustrating a recursive algorithm used with embodiments of the invention;

FIG. 5 is the recursive algorithm of FIG. 4 implemented in MATLAB® and used with embodiments of the invention.

FIG. 6 is a graph illustrating computation times of FLC systems with 2-10 inputs;

FIG. 7 is a graph illustrating computation times of FLC systems with different numbers of membership functions; and

FIG. 8 is a diagrammatic illustration of an exemplary hardware and software environment able to implement a fuzzy logic system consistent with embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Genetic fuzzy tree (GFT) methodology allows fuzzy control to be applied to big-data type problems. This technology utilizes a collection of fuzzy inference systems (FIS) with varied levels of connectivity and hence, generally requires more than 3 inputs. In order to significantly reduce the computation time, embodiments of the invention utilize a set of partitioned input membership functions for which a sum of membership values is equal to one for any crisp input. If a partitioned input is composed of triangular membership functions each with a maximum value of one, then a maximum of two membership functions will have non-zero membership value. This partitioning of input fuzzy sets will be referred to herein as fuzzy partitioning when describing embodiments of the invention below. Other embodiments may utilize trapezoidal membership functions, where the trapezoidal function is accommodated by having two triangular membership functions: one with a slope of 0 and an offset of 1, and the other with a slope of 0 and an offset of 0. Thus, only two membership values from each input need to be combined to determine the firing values for each rule. Therefore, for a four input fuzzy system with 7 membership functions each, only 2⁴=8 fuzzy rules are active in producing the crisp output of the fuzzy system instead of the 2401 fuzzy rules in contemporary systems. This significantly reduces the computational time to evaluate FIS. For example, using C implementation of embodiments of the invention on a 2.7 GHz CPU with 16 GB RAM requires 1.75 microseconds to produce an output for a 2-input systems and this times increases almost linearly to only 7.3 microseconds for a 4-input system. Further, embodiments of the invention additionally utilize a recursive algorithm based on fuzzy partitioning to implement multi-input fuzzy systems in which the implementation time is linearly proportion to the number of inputs. The simulation results discussed in relation to embodiments of the invention are carried out with different number of inputs and different number of membership functions in each input.

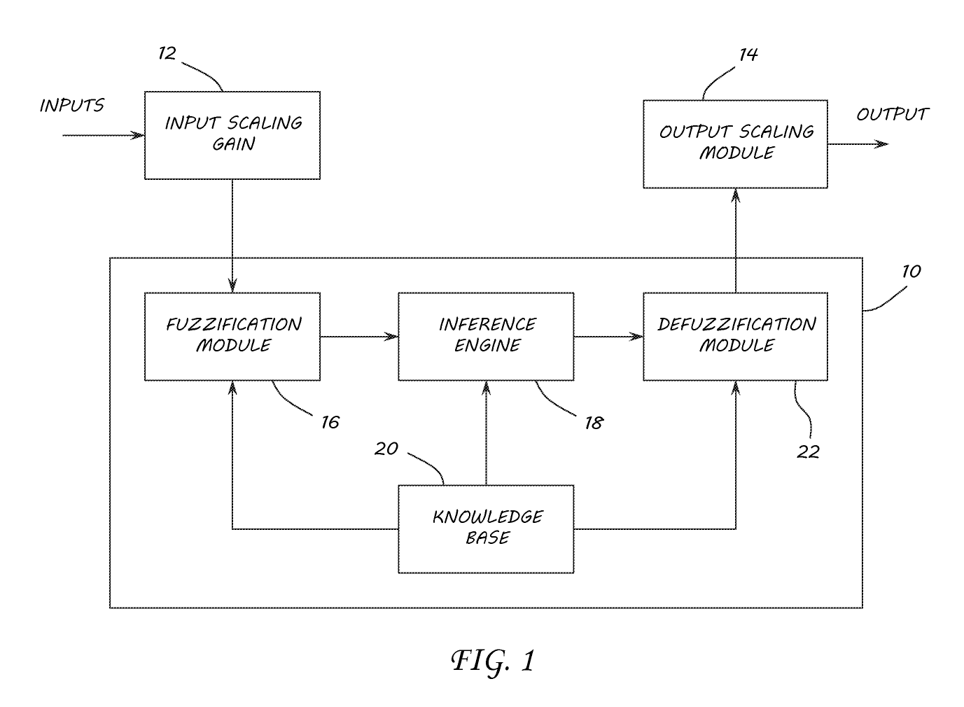

Turning now to the figures, FIG. 1 illustrates the building blocks of a Fuzzy Logic Controller (FLC) 10. The basic design parameters of the FLC 10 include input 12 and output 14 scaling factors, fuzzification 16, inference engine 18, knowledge base 20, and defuzzification 22.

The scaling factor at the input 12 is used to map the physical values of the process into a normalized universe of discourse (normalized domain). The output scaling 14 (de-normalization) is used to map the normalized output of the controller back onto the physical domain of the system.

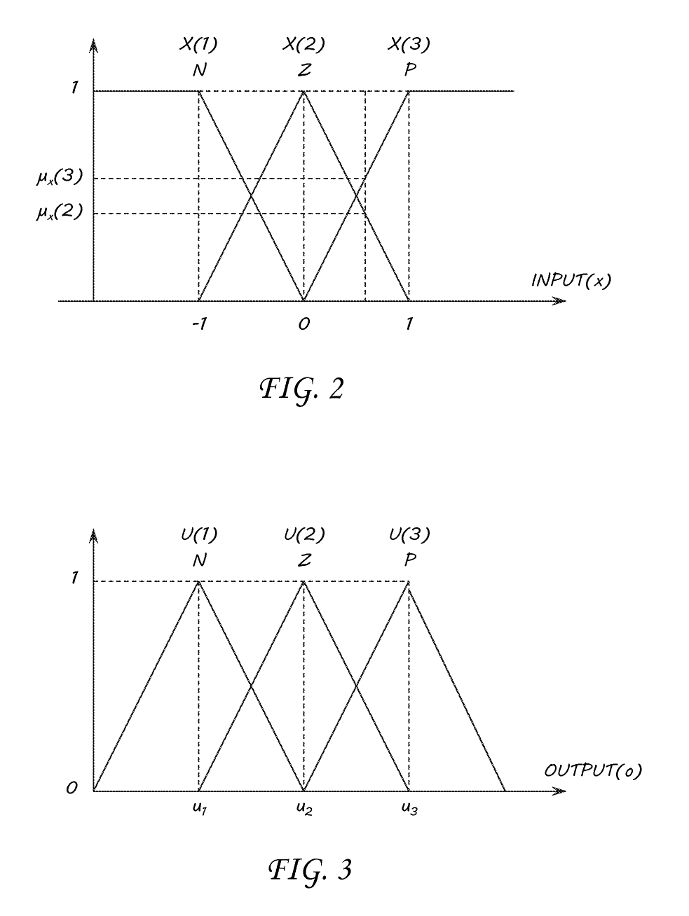

The knowledge base 20 contains knowledge of input and output fuzzy sets, and if-then fuzzy rules. Each input and output variable is partitioned into a finite number of overlapping membership functions on its universe of discourse and the if-then fuzzy rules relate the input membership functions to the output membership functions (assuming only 1-input). FIG. 2 illustrates three triangular membership functions N, Z, P, which characterize a fuzzy partitioning of input variable×defined in a normalized domain [−1, 1]. The middle function, zero (Z) is centered at zero with the remaining membership functions, negative (N) and positive (P) dividing the universe of discourse from −1 to 1 symmetrically with center point at −1 and 1, respectively. In some embodiments, the width of the input membership functions extends to the center point (peak value) of adjacent membership functions as illustrated in FIG. 2. Therefore, only two adjacent membership functions are active for any crisp input and the sum of the their membership values is equal to one, i.e., μₓ(j)+μₓ(j+1)=1.

Linguistic rules express the relationship between the inputs and output membership functions and can be written in terms of if-then rules, such as:

Rₙ: if inputn is Xₙ(n) and . . . and input2 is X₂(k) and input1 is X₁(j) then output is U(n . . . kj)

where:

1≦j≦ (number of membership functions within input1 fuzzy set (X₁(j)),

1≦k≦ (number of membership functions within input2 fuzzy set (X₂(k)), . . .

1≦n≦ (number of membership functions within inputn fuzzy set (Xₙ(n)), and

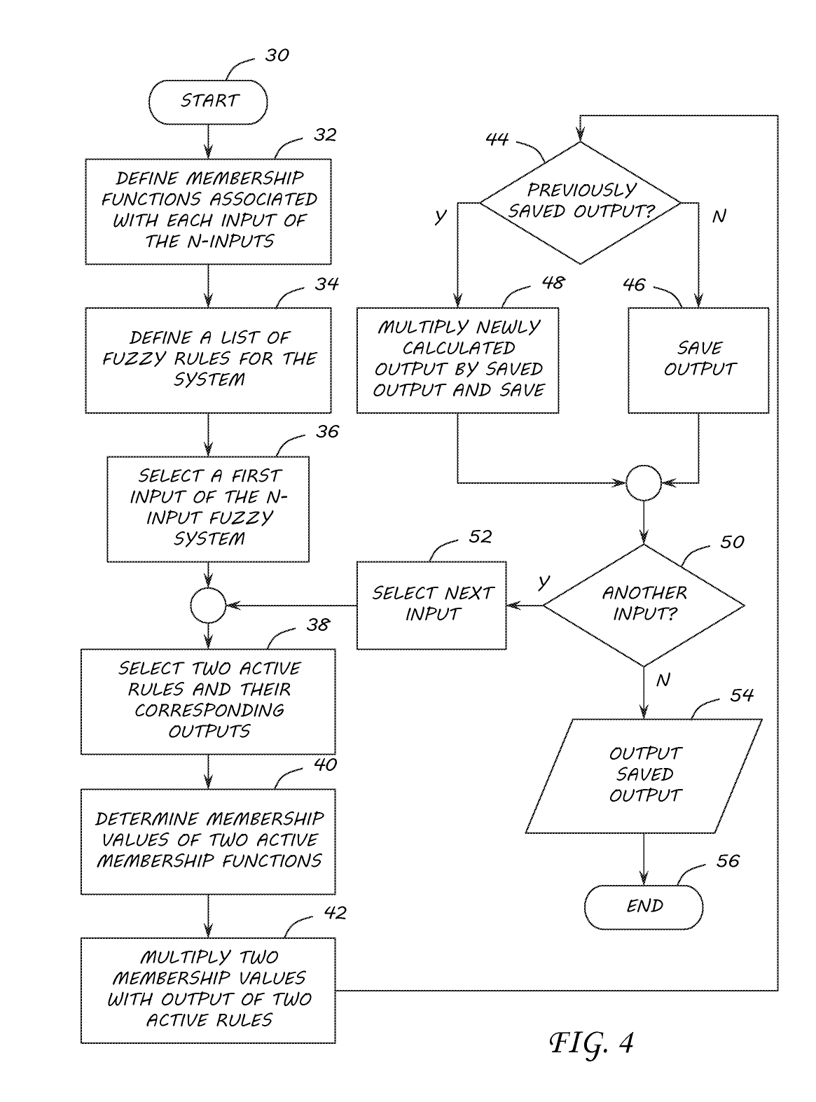

U(n . . . kj) is one of the membership functions in output fuzzy set shown in FIG. 3.

Note that the rules are listed in the order of all combinations of first membership function of inputn, . . . , first membership function of input2, and all membership functions of input1 (3 rules in this case) followed by the all combinations of first membership function of inputn, . . . , second membership function of input2, (3 rules) and so on. If three membership functions in the output fuzzy set are assumed, the rule list for an n-input fuzzy system may be written as

$$[ \begin{matrix}Rule Location \\ 1 \\ 2 \\ 3 \\ 4 \\ ⋮ \\ {3}^{n}\end{matrix} ] [ \begin{matrix}{x}_{n} & … & {x}_{2} & {x}_{1} \\ {X}_{n} ( 1 ) & … & {X}_{2} ( 1 ) & {X}_{1} ( 1 ) \\ {X}_{n} ( 1 ) & … & {X}_{2} ( 1 ) & {X}_{1} ( 1 ) \\ {X}_{n} ( 1 ) & … & {X}_{2} ( 1 ) & {X}_{1} ( 1 ) \\ {X}_{n} ( 1 ) & … & {X}_{2} ( 1 ) & {X}_{1} ( 1 ) \\ ⋮ & … & ⋮ & ⋮ \\ {X}_{n} ( 3 ) & … & {X}_{2} ( 1 ) & {X}_{1} ( 1 )\end{matrix} ] [ \begin{matrix}u \\ U ( 1 … 11 ) \\ U ( 1 … 12 ) \\ U ( 1 … 13 ) \\ U ( 1 … 21 ) \\ ⋮ \\ U ( 1 … 33 )\end{matrix} ] \qquad ( 1 )$$

For a given crisp input, fuzzification finds the degree of membership in each membership function. In FIG. 2, if the input x has a value between the center points of membership function Z(X(2)) and P(X(3)), fuzzy sets X(2) and X(3) are active and the input has membership values of μₓ(2) and μₓ(3) in fuzzy set X(2) and X(3), respectively. The input has a membership value μₓ(1)=0 in membership function X(1). Now, if x(j) is the center point of the membership function X(j), then the membership values in fuzzy sets X(j) and X(j+1) can be calculated using equations (2) and (3), respectively as

$$\begin{matrix}{μ}_{x} ( j ) = \frac{x ( j + 1 ) - x}{x ( j + 1 ) - x ( j )} & ( 2 ) \\ {μ}_{x} ( j + 1 ) = \frac{x - x ( j )}{x ( j + 1 ) - x ( j )} & ( 3 )\end{matrix}$$

Note that the sum of the membership values over the interval between two adjacent sets is one, i.e., μₓ(j)+μₓ(j+1)=1. Therefore, the sum of all membership over the universe of discourse at any instant for a control variable will always be equal to one.

Fuzzy inference (rule evaluation) module 18 determines the implication of each active rule (rule strength) by multiplying (PRODUCT for AND fuzzy implication) the degree of membership obtained during the fuzzification module. For a 2-input exemplary system, the strength of a rule n is given by

μₙ=μₓ₂(index₂)×μₓ₁(index₁) (4)

The consequent of each rule is then determined by weighing the output membership function by its strength. The output of the fuzzy inference module is the fuzzy set determined by combining maximum value (maximum for OR) of all the weighted consequences.

In many instances, such as control systems, it may be necessary to convert the fuzzy set obtained from the fuzzy inference module to a crisp value and then send this value to a process being controlled. This function is carried out by the defuzzification module 22. A contemporary frequently used method is the Centroid (center of gravity) or center of area method. This method computes an area underneath an output fuzzy set produced by the inference module 18. The value at the center of the combined area is taken as the output crisp value. However, this method may also be computationally expensive for real-time systems. Therefore, a technique referred to as a simplified reasoning method (also known as the modified centroid of area method) may be used with some embodiments of the invention, though other embodiments may use other methods. This method uses a weighted average of rule strength of each fuzzy rule obtained from fuzzy inference module 18 and the center points of the output membership function for that rule. The weighted average of the output center values and the rule strengths gives the output expression of the fuzzy system as

$$out ( n ) = \frac{{\sum }_{i = 1}^{{2}^{n}} {μ}_{i} {u}_{i}}{{\sum }_{i = 1}^{{2}^{n}} {μ}_{i}} \qquad ( 5 )$$

where n is the number of inputs, μᵢ is the center value of the membership function in the output fuzzy set for the i^{th} rule and μᵢ is the product rule applied to the antecedent of the i^{th} fuzzy rule for the n—input system given by

$${μ}_{i} = {\prod }_{m = 1}^{n} {μ}_{xm} ( {index}_{m} of the {i}^{th} rule ) .$$

Note that if fuzzy partitioning is assumed, the sum of the product of the membership values for the 2ⁿ active rule (denominator in equation (5)) is equal to one. Therefore, the output of the fuzzy system with n—inputs is given by

$$out ( n ) = {\sum }_{i = 1}^{{2}^{n}} {μ}_{i} {u}_{i} \qquad ( 6 )$$

The weighted average method is computationally less expensive compared to the center of gravity method. However, in equation (6), the membership value μᵢ is computed using the membership values of every membership function in each input to form the firing value for each rule. As the number of membership functions and the number of inputs increase, the time taken to find μᵢ becomes an obstacle for practical application of multi-input fuzzy system. One way to significantly reduce the computation time is to use partitioned triangular membership functions for which a maximum of two membership functions have non-zero membership value. Thus, only two membership values from each input need to be combined to determine the firing values for each rule. Therefore, for a four input fuzzy system with seven membership functions each, only 2⁴=8 fuzzy rules are active in producing the crisp output of the fuzzy system instead of 7⁴=2401 rules. This significantly reduces the computational time to evaluate fuzzy system as set out in more detail below.

If X₁(j) are the membership functions in the input1 (x₁) fuzzy set shown in FIG. 2 and U(o) are the membership functions in the output (u) fuzzy set shown in FIG. 3, the linguistic rules describing a 1-input, 1-output (n=1) fuzzy system in natural language are of the form:

if input1 x₁ is X₁(j) then output u is U(o)

where:

1≦j≦ (number of membership functions within the input1 fuzzy set (X₁(j)) and

1≦o≦ (number of membership functions within the output fuzzy set U(o).

If both the input and output variables have three membership functions, the list of 3 rules (R1 . . . R3) in natural language may be written as:

R₁: if input x₁ is X₁(1) then output u is U(1)

R₂: if input x₁ is X₁(2) then output u is U(2)

R₃: if input x₁ is X₁(3) then output u is U(3) (7)

Note that the number of fuzzy rules depends only on the number of membership functions in the input and does not depend on the number of output membership functions. Therefore, the number of output fuzzy sets does not have to be equal to the number of input fuzzy sets. For a 1-input fuzzy system (for example, proportional fuzzy controller) with 3 fuzzy sets (N, Z and P) for input and output shown in FIGS. 2 and 3, the rule-base can be written as

$$[ \begin{matrix}Rule Location \\ 1 \\ 2 \\ 3\end{matrix} ] [ \begin{matrix}{x}_{1} \\ {X}_{1} ( 1 ) \\ {X}_{1} ( 2 ) \\ {X}_{1} ( 3 )\end{matrix} ] [ \begin{matrix}u \\ U ( 1 ) \\ U ( 2 ) \\ U ( 3 )\end{matrix} ] ⇒ [ \begin{matrix}{x}_{1} \\ N \\ Z \\ P\end{matrix} ] [ \begin{matrix}u \\ N \\ Z \\ P\end{matrix} ] \qquad ( 8 )$$

Now, if the normalized value of the input x₁ lies within the center points of membership functions X(2) and X(3), then the two active rules from the list of rules given in equation (8) are given by

$$[ \begin{matrix}{index}_{1} \\ 2 \\ 3\end{matrix} ] [ \begin{matrix}{x}_{1} \\ {X}_{1} ( 2 ) \\ {X}_{1} ( 3 )\end{matrix} ] [ \begin{matrix}u \\ U ( 2 ) \\ U ( 3 )\end{matrix} ] \qquad ( 9 )$$

The index of the first active rule is index₁¹=2 and the index of the second rule is index₁²=3. For this example, if u(2) and u(3) are the center points of output fuzzy sets U(2) and U(3), respectively in equation (8), the output of the rule-list is represented as 2×1 matrix in equation (10) as

$${A}_{1} = [ \begin{matrix}u ( 2 ) \\ u ( 3 )\end{matrix} ] = [ \begin{matrix}a ( 1 ) \\ a ( 2 )\end{matrix} ] \qquad ( 10 )$$

Using equation (6), the output of the 1-input, 1-output fuzzy system is given by

$$\begin{matrix}\begin{matrix}out ( 1 ) = {μ}_{x 1} ( {index}_{1}^{1} ) \times a ( 1 ) + {μ}_{x 1} ( {index}_{1}^{2} ) \times a ( 2 ) \\ = [ \begin{matrix}{μ}_{x 1} ( {index}_{1}^{1} ) & {μ}_{x 1} ( {index}_{1}^{2} ) \end{matrix} ] \times {A}_{1} \\ = f ( 1 )\end{matrix} & ( 11 ) \\ where & \\ f ( i ) = {μ}_{x 1} ( {index}_{1}^{1} ) \times a ( i ) + {μ}_{x 1} ( {index}_{1}^{2} ) \times a ( i + 1 ) & ( 12 )\end{matrix}$$

is the output of the two adjacent active rules for input1 (2^{nd} and 3^{rd} rules for this example).

For a 2-inputs 1-output fuzzy system (n=2), the linguistic rules can be described in natural language as

if input2(x₂) is X₂(k) and input1(x₁) is X₁(j) then output is U(kj)

where 1≦j≦ (number of membership functions within input1 fuzzy set (X₁(j))), 1≦k≦ (number of membership functions within input2 fuzzy set (X₂(k))), and U(kj) is one of the membership function in output fuzzy set shown in FIG. 3. If each input variable has three membership functions, there are 9 rules (R₁ . . . R₉). Note that the rules are listed in the order of all combinations of first membership function of input2 and all membership functions of input1 (3 rules in this case) followed by the second membership functions of input2 and all membership functions of input1 (3 rules in this case) and so on. If three membership functions in the output fuzzy set are assumed, the rule list for a 2-input proportional plus derivative (PD) controller may be written as

$$[ \begin{matrix}Rule Location \\ 1 \\ 2 \\ 3 \\ 4 \\ 5 \\ 6 \\ 7 \\ 8 \\ 9\end{matrix} ] [ \begin{matrix}{x}_{2} & {x}_{1} \\ {X}_{2} ( 1 ) & {X}_{1} ( 1 ) \\ {X}_{2} ( 1 ) & {X}_{1} ( 2 ) \\ {X}_{2} ( 1 ) & {X}_{1} ( 3 ) \\ {X}_{2} ( 2 ) & {X}_{1} ( 1 ) \\ {X}_{2} ( 2 ) & {X}_{1} ( 2 ) \\ {X}_{2} ( 2 ) & {X}_{1} ( 3 ) \\ {X}_{2} ( 3 ) & {X}_{1} ( 1 ) \\ {X}_{2} ( 3 ) & {X}_{1} ( 2 ) \\ {X}_{2} ( 3 ) & {X}_{1} ( 3 )\end{matrix} ] [ \begin{matrix}u \\ U ( 11 ) \\ U ( 12 ) \\ U ( 13 ) \\ U ( 21 ) \\ U ( 22 ) \\ U ( 23 ) \\ U ( 31 ) \\ U ( 32 ) \\ U ( 33 )\end{matrix} ] ⇒ [ \begin{matrix}{x}_{2} & {x}_{1} \\ N & N \\ N & Z \\ N & P \\ Z & N \\ Z & Z \\ Z & P \\ P & N \\ P & Z \\ P & P\end{matrix} ] [ \begin{matrix}u \\ N \\ N \\ Z \\ N \\ Z \\ P \\ Z \\ P \\ P\end{matrix} ] \qquad ( 13 )$$

Now, if the normalized value of input1 lies within the center points of membership functions Z(X₁(2)) and P(X₁(3)) and the normalized value of input2 lies within the center points of membership functions N(X₂(1)) and Z(X₂(2)), then the four active rules from the rule list given in (14) are given by

$$[ \begin{matrix}Rule Location \\ 2 \\ 3 \\ 5 \\ 6\end{matrix} ] [ \begin{matrix}{index}_{2} & {index}_{1} \\ 1 & 2 \\ 1 & 3 \\ 2 & 2 \\ 2 & 3\end{matrix} ] [ \begin{matrix}{x}_{2} & {x}_{1} \\ {X}_{2} ( 1 ) & {X}_{1} ( 2 ) \\ {X}_{2} ( 1 ) & {X}_{1} ( 3 ) \\ {X}_{2} ( 2 ) & {X}_{1} ( 2 ) \\ {X}_{2} ( 2 ) & {X}_{1} ( 3 )\end{matrix} ] [ \begin{matrix}u \\ U ( 12 ) \\ U ( 13 ) \\ U ( 22 ) \\ U ( 23 )\end{matrix} ] \qquad ( 14 )$$

Note again that the number of active rules (2²=4 for two inputs) depend only on the number of inputs and not on the number of rules (9 in this case). Once the location of the first active rule is known, the location of the rest of the rules can be obtained from the list of rules given in equation (14) using this location. The location of the first active rule, L(1), in the list of rules given in equation (14) can be obtained using the following equation

L(1)=(index₁¹+(index₂¹−1)×(no of membership functions in input2)) (15)

where index₁¹ is the value of the first active membership function in input1 fuzzy set (2 for the above example) and index₂¹ is the value of the first active membership function in input2 fuzzy set (1 for the above example). Therefore, L(1)=2+(1−1)*3=2. Since two adjacent membership functions are active for each input, the location of the second active rule is always equal to L(2)=L₁+1 and the location of the fourth active rule is equal to L(4)=L₃+1. The location of the third active rule is given by L(3)=L(1)+number of fuzzy sets in input1. Therefore, L(3)=2+3=5 for the above example. Note also index₁²=3 and index₂²=2. Now, if u(2), u(3), u(5) and u(6) are the center points of output fuzzy sets U(12), U(13), U(22) and U(23), respectively in equation (14), the four rule listed above can be represented as 2×2 matrix in equation (16) as

$${A}_{2} = [ \begin{matrix}u ( 2 ) & u ( 5 ) \\ u ( 3 ) & u ( 6 )\end{matrix} ] = [ \begin{matrix}{A}_{1} & {A}_{1}^{′}\end{matrix} ] \qquad ( 16 )$$

where A1 is a 2×1 vector containing the center points of two adjacent active rules of input1 for the first active membership function of input2 and t and

$${A}_{1}^{′} = [ \begin{matrix}u ( 5 ) \\ u ( 6 )\end{matrix} ] = [ \begin{matrix}a ( 3 ) \\ a ( 4 )\end{matrix} ] \qquad ( 17 )$$

is a 2×1 vector containing the center points of the two active rules of input1 for the second active membership function of input2. Using equation (6), the output of fuzzy system with 2-inputs, 1—output is given by

$$\begin{matrix}out ( 2 ) = {μ}_{x 2} ( {index}_{2}^{1} ) ( {μ}_{x 1} ( {index}_{1}^{1} ) a ( 1 ) + {μ}_{x 1} ( {index}_{1}^{2} ) a ( 2 ) ) + \\ {μ}_{x 2} ( {index}_{2}^{2} ) ( {μ}_{x 1} ( {index}_{1}^{1} ) a ( 3 ) + {μ}_{x 1} ( {index}_{1}^{2} ) a ( 4 ) ) \\ = [ {μ}_{x 2} ( {index}_{2}^{1} ) {μ}_{x 2} ( {index}_{2}^{2} ) ] \\ [ \begin{matrix}{μ}_{x 1} ( {index}_{1}^{1} ) \times a ( 1 ) + {μ}_{x 1} ( {index}_{1}^{2} ) \times a ( 2 ) \\ {μ}_{x 1} ( {index}_{1}^{1} ) \times a ( 3 ) + {μ}_{x 1} ( {index}_{1}^{2} ) \times a ( 4 )\end{matrix} ] \\ = [ {μ}_{x 2} ( {index}_{2}^{1} ) {μ}_{x 2} ( {index}_{2}^{2} ) ] [ \begin{matrix}f ( 1 ) \\ f ( 3 )\end{matrix} ] \\ = g ( 2 , 2 )\end{matrix} \qquad ( 18 )$$

where f(1) is the output of the 1—input system using the membership values of two active membership functions of input1 μₓ₁ (index₁¹) and μₓ₁ (index₁²) and the center points of the first two adjacent active output membership functions (2²/2) obtained from the list of rules using equation (15) and f(3) is the output of the 1-input system using the membership values of input1 μₓ₁ (index₁¹) and μₓ₁ (index₁²), and the center points of the next two adjacent active output membership functions obtained from the list of rules. Note that f(1) and f(3) are found using equation (12). These two outputs are then multiplied with the membership values of two adjacent active membership functions of input2 (μₓ₂ (index₂¹) and μₓ₂ (index₂²). This process may, in some embodiments, be implemented recursively and extended to a 3-input, 1-output system by selecting the active rules from the list of rules.

For the 3-inputs 1-output (n=3) fuzzy system with 3 membership functions in each input fuzzy set, there will be 27 linguistic rules. These rules are described in natural language as:

If input3 is X₃(l) and input2 is X₂(k) and input1 is X₁(j) then output is U(lkj) where 1≦l≦ (number of membership functions within the input3 fuzzy set (X₃(l))). If each input variable has three membership functions, there are 27 rules (R₁ . . . R₂₇). Note that the rules are listed in the order of all combinations of first membership function of input3 and all combinations of input1 and input2 membership functions followed by the rest of the membership functions of input3 and all combinations of input1 and input2 membership functions. If three membership functions in the output fuzzy sets are assumed, the rule list for the 3-input fuzzy system (such as a PID controller) may be written similar to equation (14). The location of the first active rule L(1) is given by:

L(1)=(index₁¹+(index₂¹−1)×(no of membership functions in input2)+(index₃¹−1)×(no of membership functions in input3)) (19)

where index₃¹ is the index of the first active membership function for input3. Locations of the 2^{nd}, 3^{rd}, and 4^{th} active rules location (L(2) . . . L(4)) can be found as explained above in the 2-input example. The locations of the 4 additional active rules may be obtained by adding:

(no of membership functions in input1)×(no of membership functions in input2) to the previous four locations. Now, if input1 lies with the center points of membership functions Z(X₁(2)) and P(X₁(3)) (index₁¹=2); the normalized value of input2 lies within the center points of membership functions Z(X₂(2)) and P(X₂(3)) (index₂¹=2); and the normalized value of input3 lies within the center points of membership functions N(X₃(1)) and Z(X₃(2)) (index₃¹=1), there will always be 8 active rules irrespective of the total number of rules. The location of the first active rules is calculated using equation (19) as L(1)=2+(1−1)*3+(1−1)*3=2. The locations of the second, third and fourth active rules are obtained as explained for two-input fuzzy system discussed above. Locations of the remaining four active rules may be obtained by adding (no of membership functions in input1)×(no of membership functions in input2) to the previous four locations. Therefore, L(5)=2+3*3=11, L(6)=12, L(7)=14, and L(8)=15. These eight rules can be represented as a 2×2 matrix for the first 2-inputs given in equation (16) and the center points of the additional 4 rules given in (20) as

$${A}_{3} = [ \begin{matrix}u ( 11 ) & u ( 14 ) \\ u ( 12 ) & u ( 15 )\end{matrix} ] = [ \begin{matrix}a ( 5 ) & a ( 7 ) \\ a ( 6 ) & a ( 8 )\end{matrix} ] \qquad ( 20 )$$

Using the weighted average method, the output of the 3-inputs 1-output fuzzy system is given by

$$\begin{matrix}out ( 3 ) = {μ}_{x 3} ( {index}_{3}^{1} ) [ [ \begin{matrix}{μ}_{x 2} ( {index}_{2}^{1} ) & {μ}_{x 2} ( {index}_{2}^{2} ) ] \times \end{matrix} \\ [ \begin{matrix}{μ}_{x 1} ( {index}_{1}^{1} ) {a}_{1} + {μ}_{x 1} ( {index}_{1}^{2} ) {a}_{2} \\ {μ}_{x 1} ( {index}_{1}^{1} ) {a}_{3} + {μ}_{x 1} ( {index}_{1}^{2} ) {a}_{4}\end{matrix} ] ] + \\ {μ}_{x 3} ( {index}_{3}^{2} ) [ [ \begin{matrix}{μ}_{x 2} ( {index}_{2}^{1} ) & {μ}_{x 2} ( {index}_{2}^{2} ) ] \times \end{matrix} \\ [ \begin{matrix}{μ}_{x 1} ( {index}_{1}^{1} ) {a}_{4} + {μ}_{x 1} ( {index}_{1}^{2} ) {a}_{5} \\ {μ}_{x 1} ( {index}_{1}^{1} ) {a}_{6} + {μ}_{x 1} ( {index}_{1}^{2} ) {a}_{7}\end{matrix} ] ] \\ = {μ}_{x 3} ( {index}_{3}^{1} ) [ [ \begin{matrix}{μ}_{x 2} ( {index}_{2}^{1} ) & {μ}_{x 2} ( {index}_{2}^{2} ) ] \times \end{matrix} [ \begin{matrix}f ( 1 ) \\ f ( 3 )\end{matrix} ] ] + \\ {μ}_{x 3} ( {index}_{3}^{2} ) [ [ \begin{matrix}{μ}_{x 2} ( {index}_{2}^{1} ) & {μ}_{x 2} ( {index}_{2}^{2} ) ] \times \end{matrix} [ \begin{matrix}f ( 5 ) \\ f ( 7 )\end{matrix} ] ] \\ = [ \begin{matrix}{μ}_{x 3} ( {index}_{3}^{1} ) & {μ}_{x 3} ( {index}_{3}^{2} ) ] \times [ \begin{matrix}g ( 2 , 2 ) \\ g ( 6 , 2 )\end{matrix} ]\end{matrix} \\ = g ( 6 , 3 )\end{matrix} \qquad ( 21 )$$

Note again that the first active rules are used to find f(1) and f(3) using equation (15), and the rest of the four active rules are used to calculate f(5) and f(7). As in the 2-input system, one output g(2,2) is produced by multiplying the membership values of two adjacent active membership functions of input2 (μₓ₂(index₁¹) and μₓ₂ (index₁²)) with f(1) and f(3). The second output g(6,2) is calculated by multiplying the membership values of two adjacent active membership functions of input2 (μₓ₂(index₁¹) and μₓ₂ (index₁²)) with f(5) and f(7). These outputs are then multiplied with the membership values of two adjacent active membership functions of input3 (μₓ₃(index₁¹) and μₓ₃ (index₁²)) to produce the output of the 3-input fuzzy system.

Extending this now to an n-input, 1-output fuzzy system, if Xₙ(indexₙ¹) and Xₙ(indexₙ²) are the two active membership functions for inputn, the output of the n-input fuzzy system is given as

$$out ( n ) = g ( m , n ) = [ \begin{matrix}{μ}_{xn} ( {index}_{n}^{1} ) & {μ}_{xn} ( {index}_{n}^{2} ) ]\end{matrix} \times [ \begin{matrix}g ( m - {2}^{n - 1} , n - 1 ) \\ g ( m , n - 1 )\end{matrix} ] \qquad ( 22 )$$

where m=2ⁿ−2. Note again that g(m−2ⁿ⁻¹, n−1) is the output of the fuzzy system with the first 2ⁿ⁻² active rules of n−1 inputs fuzzy system and g(m, n−1) is the output of the fuzzy system with n−1 inputs and the other 2ⁿ⁻² active rules. Therefore, equation (22) is a recursive relationship to find the output of n-input fuzzy system. This recursive relationship is illustrated in the flow diagram in FIG. 4.

Turning now to FIG. 4, the recursive process begins at block 30. Membership functions associated with each of the n-inputs are defined in block 32 and a list of fuzzy rules are defined in block 34. A first input of the n-input fuzzy system is selected in block 36. Two active rules and their corresponding outputs are selected based on the selected input in block 38. Then, membership values of the two active membership functions for the selected input are determined in block 40. The two membership values are multiplied with the outputs of the two active rules to product an output in block 42. If there is no previously saved output (“No” branch of decision block 44), then the output is saved in block 46. If there is a previously saved output (“Yes” branch of decision block 44), then the newly calculated output is multiplied by the saved output and this product is saved in block 48. After the output has been saved in either block 46 or 48 a check is made for another input. If there is another input to the n-input fuzzy system (“Yes” branch of decision block 50), then the next input is selected at block 52 and the process repeats blocks 38 through 48. If all inputs have been processed (“No” branch of decision block 50), then the saved output maybe output for use in a control system or sent to a process being controlled in block 54. The process ends at block 56.

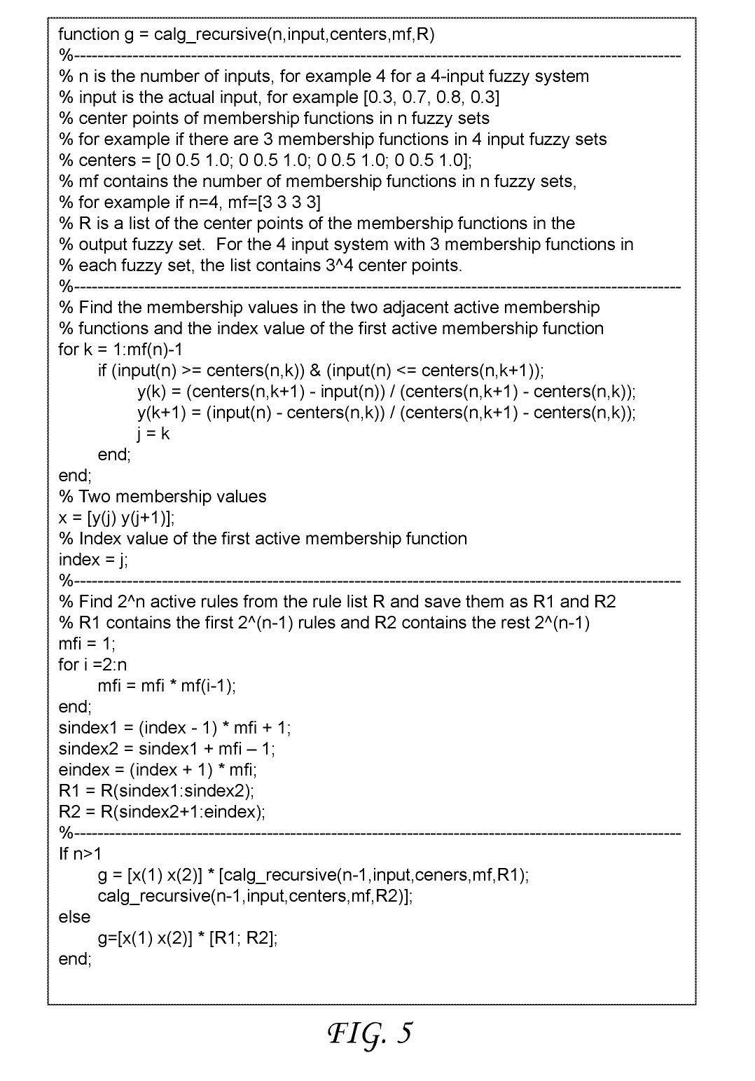

The process in the flow diagram in FIG. 4 was implemented as a Matlab function as shown in FIG. 5, though the recursive algorithm may be implemented in any programming language on any system, including hardware implementations embedded in FLCs. The inputs to the recursive function are the number of inputs (n) applied to the fuzzy system, the actual inputs (input), the center points of the membership functions in the n input fuzzy sets (centers), the number of membership functions in each fuzzy set (mf), and the rule list (R) containing the center points of the output fuzzy sets for the total number of rules.

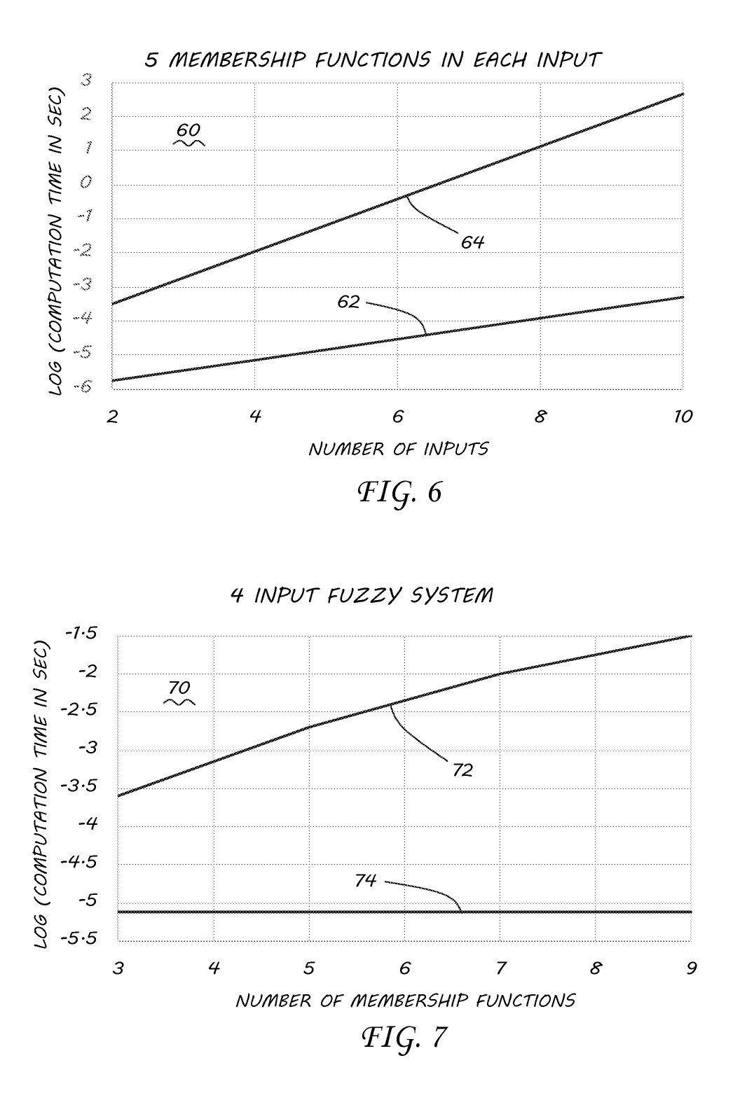

The methodology presented above and used in embodiments of the invention was used to implement fuzzy systems with 2 to 10 inputs having 5 membership functions each. Table 1 contains the computation times required to implement these fuzzy systems with the recursive methodology utilized in the embodiments of the invention and a contemporary method on a 2.7 GHz CPU with 16 GB RAM. Graph 60 in FIG. 6 shows the log of the computation time in seconds verses the number of inputs. It can be seen from Table 1 that the computation time increases linearly with the number of inputs on curve 62 related to the recursive method, whereas this time increases exponentially on curve 64 related to the contemporary method. For example, it takes 414 seconds to implement 10 inputs fuzzy system with the contemporary method due to dimensionality; however, it takes only 0.42 milliseconds to implement the same system with the recursive method. This time saving is beneficial in implementing multi-layered fuzzy tree in complex systems.

TABLE 1
Computation Times for 2 to 10 Input Fuzzy Systems

| | Number of Inputs | | | | | | | | |
|---|---|---|---|---|---|---|---|---|---|
| | 2 | 3 | 4 | 5 | 6 | 7 | 8 | 9 | 10 |
| Contemporary | 2.65E−4 | 1.77E−3 | 1.15E−2 | 6.67E−2 | 4.13E−1 | 2.28 | 14.1 | 80.2 | 414 |
| Method | | | | | | | | | |
| Recursive | 1.75E−6 | 3.6E−6 | 7.3E−6 | 1.41E−5 | 2.8E−5 | 5.4E−5 | 1.1E−4 | 2.0E−5 | 4.2E−4 |
| Method | | | | | | | | | |

The recursive method implemented in embodiments of the invention was also used to implement a 4-input fuzzy system with 3 to 9 membership functions in each input. Table 2 contains the computation times required to implement these fuzzy systems with the recursive and the contemporary methods. Graph 70 in FIG. 7 shows the log of the computation time in seconds versus the number of membership functions. It can be seen from the curves 72, 74 that the computation time for the contemporary method (curve 72) also increases rapidly whereas the times remain constant with the recursive method (curve 74).

TABLE 2
Computation Times for 4 Input Fuzzy Systems

| | Number of Membership Functions | | | |
|---|---|---|---|---|
| | 3 | 5 | 7 | 9 |
| Contemporary Method | 2.48E−4 | 1.15E−2 | 4.42E−2 | 1.12E−1 |
| Recursive Method | 3.65E−6 | 3.7E−6 | 3.74E−6 | 3.75E−6 |

For further performance gains, the fuzzy logic system may be reduced to a piecewise linear representation. Embodiments of the invention utilizing the recursive methods may be used to generate affine gains for different modes. For example, a 2-input, 1-output fuzzy system may be represented as:

out(2)=K₁x₁+K₂x₂+K₁₂x₁×x₂+Const (23)

K₁ is the gain for input x₁. K₂ is the gain for input x₂. K₁₂ is the nonlinear term gain and Const is a constant term. All of the gains and the constant may be determined using embodiments of the invention. Setting the first term x₁ to its normalized extremes of [−1, 1] in the equation will result in the gain value for K₁.

$${K}_{1} = \frac{1}{D} [ {x}_{2} ( k + 1 ) ( u ( 2 ) - u ( 1 ) ) - {x}_{2} ( k ) ( u ( 4 ) - u ( 3 ) ) ] = \frac{1}{D} [ \begin{matrix}{x}_{2} ( k + 1 ) & - {x}_{2} ( k ) ] {A}_{1} [ \begin{matrix}- 1 \\ 1\end{matrix} ]\end{matrix} \qquad ( 24 )$$

Similarly, setting the second term x₂ to its normalized extremes of [−1, 1] will result in the gain value for K₂.

$${K}_{2} = \frac{1}{D} [ {x}_{1} ( j + 1 ) ( u ( 2 ) - u ( 1 ) ) - {x}_{1} ( j ) ( u ( 4 ) - u ( 3 ) ) ] = \frac{1}{D} [ \begin{matrix}- 1 & 1 ] {A}_{1}\end{matrix} [ \begin{matrix}{x}_{1} ( j + 1 ) \\ - {x}_{1} ( j )\end{matrix} ] \qquad ( 25 )$$

Setting both x₁ and x₂ to [−1, 1] will results in the gain value for K₁₂.

$${K}_{12} = \frac{1}{D} [ ( u ( 1 ) - u ( 2 ) ) - ( u ( 3 ) - u ( 4 ) ) ] = \frac{1}{D} [ \begin{matrix}- 1 & 1 ] {A}_{1}\end{matrix} [ \begin{matrix}- 1 \\ 1\end{matrix} ] \qquad ( 26 )$$

Finally, setting x₁ and x₂ to their center values will result in Const constant value.

$$Const = \frac{1}{D} [ {x}_{2} ( k + 1 ) ( {x}_{1} ( j + 1 ) u ( 2 ) - {x}_{1} ( j ) u ( 1 ) ) - {x}_{2} ( k ) ( {x}_{1} ( j + 1 ) u ( 3 ) - {x}_{1} ( j ) u ( 4 ) ) ] = \frac{1}{D} [ \begin{matrix}{x}_{2} ( k + 1 ) & - {x}_{2} ( k ) ] {A}_{1}\end{matrix} [ \begin{matrix}{x}_{1} ( j + 1 ) \\ - {x}_{1} ( j )\end{matrix} ] \qquad ( 27 )$$

D=(x₁(j+1)−x₁(j))×(x₂(k+1)−x₂(k)) for equations 24-27 above. These gains and constant value may now be inserted into equation (23) and utilized by a control system to obtain an output from the two inputs. This piecewise representation of the fuzzy system may be realized in any number of hardware configurations within the control system, such as in an ASIC or FPGA.

This same process may be extended to any n-input, 1-output system, with the embodiments of the invention being utilized to calculate the coefficients (gains) and constant as set out above. As a further example, a piecewise representation for a 3-input system is:

out (3)=K₁x₁+K₂x₂+K₃x₃+K₁₂x₁×x₂+K₁₃x₁×x₃+K₂₃x₂×x₃+K₁₂₃x₁×x₂×x₃+Const (28)

Similar to the 2 input system, K₁, K₂, and K₃ are gains for inputs x₁, x₂, and x₃ respectively. K₁₂, K₁₃, K₂₃, and K₁₂₃ are the gains for the nonlinear terms. And, Const is the constant term. For each of the equations below, D=(x₁(j+1)−x₁(j))×(x₂(k+1)×x₂(k))×(x₃(l+1)−x₃(l)).

$$\begin{matrix} {K}_{1} = \frac{1}{D} [ \begin{matrix}{x}_{3} ( l + 1 ) & - {x}_{3} ( l ) ]\end{matrix} [ \begin{matrix}[ \begin{matrix}{x}_{2} ( k + 1 ) & - {x}_{2} ( k ) ]\end{matrix} & {A}_{1} [ \begin{matrix}- 1 \\ 1\end{matrix} ] \\ [ \begin{matrix}{x}_{2} ( k + 1 ) & - {x}_{2} ( k ) ]\end{matrix} & {A}_{2} [ \begin{matrix}- 1 \\ 1\end{matrix} ]\end{matrix} ] & ( 29 ) \\ {K}_{2} = \frac{1}{D} [ \begin{matrix}{x}_{3} ( l + 1 ) & - {x}_{3} ( l ) ] [ \begin{matrix}[ \begin{matrix}- 1 & 1 ]\end{matrix} & {A}_{1} [ \begin{matrix}{x}_{1} ( j + 1 ) \\ - {x}_{1} ( j )\end{matrix} ] \\ [ \begin{matrix}- 1 & 1 ]\end{matrix} & {A}_{2} [ \begin{matrix}{x}_{1} ( j + 1 ) \\ - {x}_{1} ( j )\end{matrix} ]\end{matrix} ]\end{matrix} & ( 30 ) \\ {K}_{3} = \frac{1}{D} [ \begin{matrix}- 1 & 1 ]\end{matrix} [ \begin{matrix}[ \begin{matrix}{x}_{2} ( k + 1 ) & - {x}_{2} ( k ) ]\end{matrix} & {A}_{1} [ \begin{matrix}{x}_{1} ( j + 1 ) \\ - {x}_{1} ( j )\end{matrix} ] \\ [ \begin{matrix}{x}_{2} ( k + 1 ) & - {x}_{2} ( k ) ]\end{matrix} & {A}_{2} [ \begin{matrix}{x}_{1} ( j + 1 ) \\ - {x}_{1} ( j )\end{matrix} ]\end{matrix} ] & ( 31 ) \\ {K}_{12} = \frac{1}{D} [ \begin{matrix}{x}_{3} ( l + 1 ) & - {x}_{3} ( l ) ]\end{matrix} [ \begin{matrix}[ \begin{matrix}- 1 & 1 ]\end{matrix} & {A}_{1} [ \begin{matrix}- 1 \\ 1\end{matrix} ] \\ [ \begin{matrix}- 1 & 1 ]\end{matrix} & {A}_{2} [ \begin{matrix}- 1 \\ 1\end{matrix} ]\end{matrix} ] & ( 32 ) \\ {K}_{13} = \frac{1}{D} [ \begin{matrix}- 1 & 1 ]\end{matrix} [ \begin{matrix}[ \begin{matrix}{x}_{2} ( k + 1 ) & - {x}_{2} ( k ) ]\end{matrix} & {A}_{1} [ \begin{matrix}- 1 \\ 1\end{matrix} ] \\ [ \begin{matrix}{x}_{2} ( k + 1 ) & - {x}_{2} ( k ) ]\end{matrix} & {A}_{2} [ \begin{matrix}- 1 \\ 1\end{matrix} ]\end{matrix} ] & ( 33 ) \\ {K}_{23} = \frac{1}{D} [ \begin{matrix}- 1 & 1 ]\end{matrix} [ \begin{matrix}[ \begin{matrix}- 1 & 1 ]\end{matrix} & {A}_{1} [ \begin{matrix}{x}_{1} ( j + 1 ) \\ - {x}_{1} ( j )\end{matrix} ] \\ [ \begin{matrix}- 1 & 1 ]\end{matrix} & {A}_{2} [ \begin{matrix}{x}_{1} ( j + 1 ) \\ - {x}_{1} ( j )\end{matrix} ]\end{matrix} ] & ( 34 ) \\ {K}_{123} = \frac{1}{D} [ \begin{matrix}- 1 & 1 ]\end{matrix} [ \begin{matrix}[ \begin{matrix}- 1 & 1 ]\end{matrix} & {A}_{1} [ \begin{matrix}- 1 \\ 1\end{matrix} ] \\ [ \begin{matrix}- 1 & 1 ]\end{matrix} & {A}_{2} [ \begin{matrix}- 1 \\ 1\end{matrix} ]\end{matrix} ] & ( 35 ) \\ Const = \frac{1}{D} [ \begin{matrix}{x}_{3} ( l + 1 ) & - {x}_{3} ( l ) ]\end{matrix} [ \begin{matrix}[ \begin{matrix}{x}_{2} ( k + 1 ) & - {x}_{2} ( k ) ]\end{matrix} & {A}_{1} [ \begin{matrix}{x}_{1} ( j + 1 ) \\ - {x}_{1} ( j )\end{matrix} ] \\ [ \begin{matrix}{x}_{2} ( k + 1 ) & - {x}_{2} ( k ) ]\end{matrix} & {A}_{2} [ \begin{matrix}{x}_{1} ( j + 1 ) \\ - {x}_{1} ( j )\end{matrix} ]\end{matrix} ] & ( 36 )\end{matrix}$$

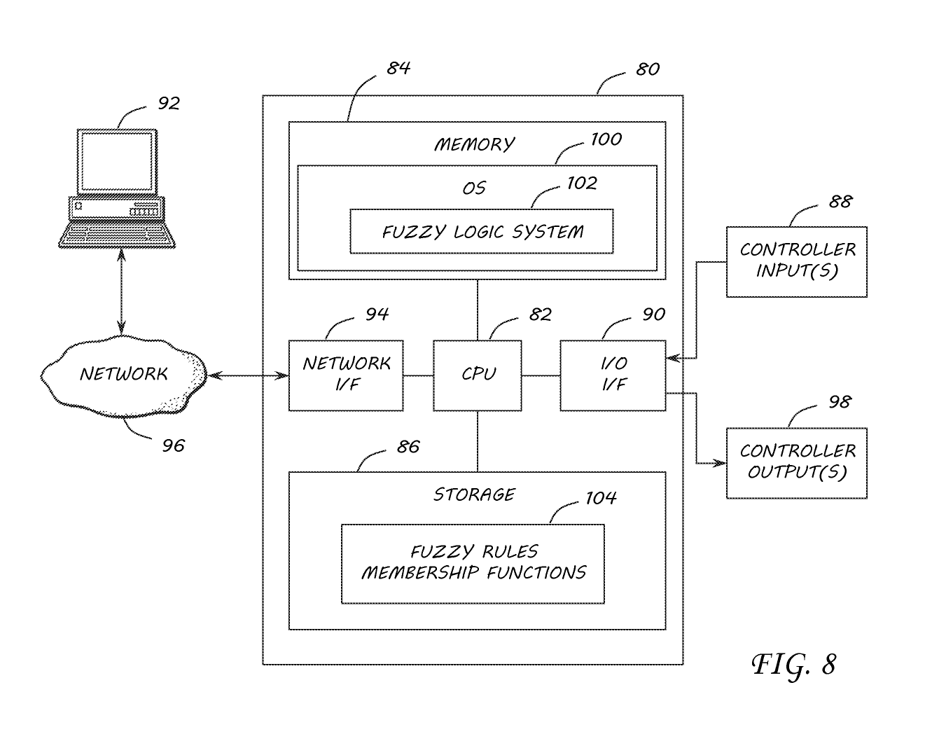

As set forth above, embodiments of the invention may be implemented in a number of different hardware configurations. FIG. 8 is a diagrammatic illustration of an exemplary hardware and software environment for a controller 80 capable of implementing a fuzzy logic system consistent with embodiments of the invention. Controller 80, in specific embodiments, may be a general purpose processor, application specific integrated circuit (ASIC), field programmable gate array (FPGA), computer, computer system, computing device, server, disk array, or programmable device such as a multi-user computer, a single-user computer, a handheld computing device, a networked device (including a computer in a cluster configuration), a mobile telecommunications device, etc.

The controller 80 includes at least one central processing unit (“CPU”) 82 coupled to a memory 84. Each CPU 12 is typically implemented in hardware using circuit logic disposed on one or more physical integrated circuit devices or chips. Each CPU 82 may be one or more microprocessors, micro-controllers, field programmable gate arrays, or ASICs, while memory 84 may include random access memory (RAM), dynamic random access memory (DRAM), static random access memory (SRAM), flash memory, and/or another digital storage medium, and also typically implemented using circuit logic disposed on one or more physical integrated circuit devices, or chips. As such, memory 84 may be considered to include memory storage physically located elsewhere in the controller 80, e.g., any cache memory in the at least one CPU 82, as well as any storage capacity used as a virtual memory, e.g., as stored on a storage device 86.

The controller 80 may have at least one input 88 coupled to the controller 80 through an input/output device interface 90 (illustrated as, and hereinafter, “I/O I/F” 90). This at least one input 88 may provide controller 80 with data or other commands to access internal functionality of controller 80. Controller 80 may also receive data or other commands from another computing system 92 coupled to controller 80 through at least one network interface 94 (illustrated as, and hereinafter, “network I/F” 94) by way of at least one network 96. Controller 80 may also provide output to at least one controller output 98 for communication with a user or provided to a process being controlled.

The controller 80 is typically under the control of an operating system 100 and executes or otherwise relies upon various software applications, sequences of operations, components, programs, files, objects, modules, etc., consistent with embodiments of the invention. In specific embodiments, the controller 80 may execute or otherwise rely upon a fuzzy logic system 102 consistent with embodiments of the invention manage input data, as well as generate controller outputs. Moreover, and in specific embodiments, the controller 80 may be configured with a database 104 to store data related to fuzzy rules and membership functions consistent with embodiments of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method of determining an output of an n-input fuzzy logic system, the method comprising:
determining a plurality of membership functions associated with a corresponding plurality of inputs to the n-input fuzzy logic system;
defining a list of fuzzy rules for the n-input fuzzy logic system;
selecting an input of the plurality of inputs;
selecting two active rules and their corresponding output values from the list of rules based on the selected input;
determining membership values of two active membership functions based on the selected input;
calculating an output of the n-input fuzzy system by multiplying the two membership values with the output of the two active rules;
saving the calculated output;
in response to additional inputs of the plurality of inputs, recursively repeating for each additional input of the plurality of inputs:
selecting of an additional input of the plurality of inputs;
determining two active rules and corresponding output values from the list of rules based on the selected additional input;
determining membership values of two active membership functions based on the selected additional input;
calculating an intermediate output of the n-input fuzzy system by multiplying the two membership values with the output of the two active rules based on the selected additional input;
multiplying the saved calculated output and the calculated intermediate output; and
saving the multiplied calculated output; and
in response to no additional inputs of the plurality of inputs, outputting the saved calculated output.

2. The method of claim 1, wherein the active membership functions are triangular membership functions.

3. The method of claim 2, wherein the active membership functions are adjacent and overlap.

4. The method of claim 3, wherein the active membership functions terminate at a center-point of adjacent membership functions.

5. The method of claim 3, wherein a sum of membership values for the active membership functions is 1.

6. The method of claim 1, wherein the plurality of inputs are normalized.

7. The method of claim 6, wherein the plurality of inputs are normalized to a value of 1.

8. A method of reducing a fuzzy logic system to a piecewise linear representation, the method comprising:
determining a plurality of gains associated with each of a plurality of inputs of an n-input fuzzy system by:
setting an input of the plurality of inputs to normalized extreme values;
determining an output of a fuzzy system using the method of claim 1 with the set inputs; and
setting a gain of the plurality of gains corresponding to the input of the plurality of inputs to the determined output; and
repeating for each input of the plurality of inputs;
determining a plurality of nonlinear gains associated with combinations of the inputs of the plurality of inputs by:
setting each input of the plurality of inputs in a combination of the inputs to the normalized extreme values;
determining an output of a fuzzy system using the method of claim 1 with the set inputs;
setting a gain of the plurality of gains corresponding to the combination of inputs to the determined output; and
repeating for each combination of inputs of the plurality of inputs; and
determining a constant of the piecewise linear representation of the fuzzy logic system by:
setting each input of the plurality of input to its corresponding center value;
determining an output of a fuzzy system using the method of claim 1 with the set inputs;
setting the constant to the determined output.

9. The method of claim 8, wherein the normalized extreme values are −1 and 1.

10. A controller, comprising
a memory;
a processor;
program code, resident in the memory and configured to determine a controller output when executed by the processor;
the program code further configured to determine a plurality of membership functions associated with a corresponding plurality of inputs to the n-input fuzzy logic system, define a list of fuzzy rules for the n-input fuzzy logic system, select an input of the plurality of inputs, select two active rules and their corresponding output values from the list of rules based on the selected input, determining membership values of two active membership functions based on the selected input, calculate an output of the n-input fuzzy system by multiplying the two membership values with the output of the two active rules, and save the calculated output;
the program code further configured, in response to additional inputs of the plurality of inputs, to recursively repeat for each additional input of the plurality of inputs:
selecting of an additional input of the plurality of inputs;
determining two active rules and corresponding output values from the list of rules based on the selected additional input;
determining membership values of two active membership functions based on the selected additional input;
calculating an intermediate output of the n-input fuzzy system by multiplying the two membership values with the output of the two active rules based on the selected additional input;
multiplying the saved calculated output and the calculated intermediate output; and
saving the multiplied calculated output; and
the program code further configured, in response to no additional inputs of the plurality of inputs, to output the saved calculated output.

11. The controller of claim 10, wherein the active membership functions are triangular membership functions.

12. The controller of claim 11, wherein the active membership functions are adjacent and overlap.

13. The controller of claim 12, wherein the active membership functions terminate at a center-point of adjacent membership functions.

14. The controller of claim 12, wherein a sum of membership values for the active membership functions is 1.

15. The controller of claim 10, wherein the plurality of inputs are normalized.

16. The controller of claim 15, wherein the plurality of inputs are normalized to a value of 1.
